(19) United States
(12) Patent Application Publication
(10) Pub. No.: US 2026/0078236 A1
(43) Pub. Date: Mar. 19, 2026

(54) RESIN-BASED COMPOSITE NUCLEAR SHIELDING MATERIAL AND PREPARATION METHOD THEREFOR

(71) Applicant: Huaneng Nuclear Energy Technology Research Institute Co., Ltd., Shanghai (CN)

(72) Inventors: Wei WANG, Shanghai (CN); Jingbin XI, Shanghai (CN); Jianjun LIU, Shanghai (CN); Zhijun WU, Shanghai (CN); Jingjing JIA, Shanghai (CN); Bin ZHANG, Shanghai (CN); Na AN, Shanghai (CN); Qiangqiang YANG, Shanghai (CN)

(21) Appl. No.: 18/885,485

(22) Filed: Sep. 13, 2024

(30) Foreign Application Priority Data
Nov. 13, 2023 (CN) 202311503496X

(51) Int. Cl. C08K 3/04; C08K 3/22

(52) U.S. Cl. CPC C08K 3/041; C08K 3/22; C08K 2003/2258; C08K 2201/011

(57) ABSTRACT

Disclosed in the present invention is a resin-based composite nuclear shielding material, including the following raw materials in percentage by mass: 37%-41% of resin, 46%-53% of functional filler, 3%-7% of curing agent and 3%-10% of silane coupling agent. The resin-based composite nuclear shielding material provided by the present invention includes the resin with high mechanical property and the functional filler with high radiation protection property. The addition of a proper number of carbon nanotubes has a certain effect of improving the tensile strength and bending strength of an epoxy resin-based composite material. The nuclear shielding material provided by the present invention is lightweight, controllable in density and easy to process and mold. The resin selected by the nuclear shielding material provided by the present invention has excellent tensile property, thermal stability and corrosion resistance.

### CROSS-REFERENCE TO RELATED APPLICATIONS

The present application claims priority to Chinese Patent Application No. 202311503496X, filed on Nov. 13, 2023, the entire disclosure of which is incorporated herein by reference.

### TECHNICAL FIELD

The present invention belongs to the field of nuclear radiation shielding, and in particular, relates to a resin-based composite nuclear shielding material and a preparation method therefor.

### BACKGROUND

Nuclear energy is clean, safe and economical energy, and is gradually becoming an important part of a global energy structure. Developing a safe and efficient nuclear power technology has become an important measure for China to adjust and optimize an existing energy structure and establish a “clean, low-carbon, safe and efficient” modern energy system. In this context, the safety problems involved in the application process of nuclear energy have attracted more and more attention. Nuclear radiation is microscopic particle flow released by energy transfer and morphological structure change of nuclei of radioactive substances, mainly including X-rays, α-rays, β-rays, γ-rays and neutron rays. These rays have certain penetrability and can react with the nuclei of other objects to act on a human body to cause different degrees of harm. Doing a good protection job on nuclear radiation is the key to ensure nuclear safety. The traditional nuclear radiation protection material usually uses a lead plate and concrete, has the disadvantages of high density and inconvenient movement, and is not suitable for some special occasions.

### SUMMARY

The purpose of this part is to outline some aspects of the embodiments of the present invention and to briefly describe some preferred embodiments. Some simplifications or omissions may be made in the present part as well as the abstract of the specification and the title of invention of the present application, so as not to obscure the objective of the present part as well as the abstract of the specification and the title of invention, however, such simplifications or omissions cannot be used for limiting the scope of the present invention.

The present invention is provided in view of the above problems or the problems in the prior art.

Therefore, an objective of the present invention is to overcome the shortcomings in the prior art, and provide a preparation method for a resin-based composite nuclear shielding material.

To solve the above technical problems, the present invention provides the following technical solution: a resin-based composite nuclear shielding material includes:
heating a resin at a constant temperature;
adding a carbon nanotube and polyvinylpyrrolidone into a deionized water solution, stirring uniformly to obtain a mixed solution, and adding functional nanoparticles into the mixed solution for stirring to obtain a solution A;
washing the solution A with deionized water and drying to obtain functional filler powder; adding the functional filler powder into an acetone solution, and performing ultrasonic dispersion for uniform mixing to obtain a solution B;
adding a silane coupling agent into the solution B, and continuously performing ultrasonic dispersion to obtain a solution C; and
adding the preheated resin into the solution C, heating and stirring until acetone is completely volatilized, adding a curing agent, stirring to mix the materials uniformly, pouring the mixture into a mold, performing curing in a vacuum drying oven and then performing demolding to obtain an epoxy resin-based composite nuclear shielding material.

As a preferred solution of the preparation method according to the present invention, the mass percentage of each raw material is as follows: 37%-41% of resin, 46%-53% of functional filler, 3%-7% of curing agent and 3%-10% of silane coupling agent.

As a preferred solution of the preparation method according to the present invention, the resin is heated in a constant-temperature water bath kettle, where a resin matrix is any one of epoxy resin, organic silicon resin and phenolic resin, and the heating temperature is 50° C.-80° C.

As a preferred solution of the preparation method according to the present invention, the mass ratio of the carbon nanotube to the polyvinylpyrrolidone is 1:1-1:2, and the ratio of the carbon nanotube to the deionized water is 1 g:(0.05-0.1) L.

As a preferred solution of the preparation method according to the present invention, in the adding functional nanoparticles into the mixed solution for stirring to obtain the solution A, the stirring time is 24-48 hours, each of the functional nanoparticles is one of tungsten oxide, lead oxide, gadolinium oxide and erbium oxide, and the mass ratio of the functional nanoparticles to the carbon nanotube is 1:1-1:2.

As a preferred solution of the preparation method according to the present invention, in the washing the solution A with deionized water and drying, the temperature is 60° C.-100° C., the time is 8-12 hours, and the ultrasonic dispersion time is 5-10 minutes.

As a preferred solution of the preparation method according to the present invention, the ratio of the functional filler powder to the acetone is 1 g:(5-10) mL, the mass ratio of the functional filler powder to the silane coupling agent is 5:1-10:1, and the mass ratio of the resin to the functional filler powder is 1:1-1:1.5.

As a preferred solution of the preparation method according to the present invention, in the heating and stirring until acetone is completely volatilized, the heating temperature is 50° C.-80° C.

As a preferred solution of the preparation method according to the present invention, the curing agent is selected from any one of diethylenetriamine, ethylenediamine, diethylenetriamine and triethylenetetramine, and the mass ratio of the curing agent to the resin is 1:7-1:10.

As a preferred solution of the preparation method according to the present invention, in the performing curing in a vacuum drying oven, the temperature is 40° C.-60° C., and the curing time is 4-6 hours. Another objective of the present invention is to overcome the shortcomings in the prior art and provide a product prepared by a preparation method for a resin-based composite nuclear shielding material.

Still another objective of the present invention is to overcome the shortcomings in the prior art and provide application of a product prepared by a preparation method for a resin-based composite nuclear shielding material to nuclear radiation shielding.

The beneficial effects of the present invention are as follows:

The resin-based composite nuclear shielding material provided by the present invention includes the resin with high mechanical property and the functional filler with high radiation protection property. The addition of a proper number of carbon nanotubes has a certain effect of improving the tensile strength and bending strength of an epoxy resin-based composite material.

The nuclear shielding material provided by the present invention is lightweight, controllable in density and easy to process and mold.

The resin selected by the nuclear shielding material provided by the present invention has excellent tensile property, thermal stability and corrosion resistance.

### DETAILED DESCRIPTION OF THE EMBODIMENTS

To make the aforementioned objectives, features and advantages of the present invention more apparent and comprehensible, the specific embodiments of the present invention are described in detail below with reference to the embodiments of the specification.

Numerous specific details are set forth in the description below to provide a thorough understanding for the present invention; however, the present invention may also be implemented in other manners different from those described herein, and those skilled in the art may make similar generalization without departing from the essence of the present invention; and therefore, the present invention is not limited by the specific embodiments disclosed below.

Secondly, it should be noted that the term “embodiment” or “embodiments” used herein refers to a particular feature, structure, or characteristic that may be incorporated into one or more implementations of the present invention. The “in one embodiment” appearing in different parts of the present specification does not necessarily refer to the same embodiment, nor a separate or selective embodiment that is mutually exclusive to other embodiments.

In the embodiments of the present invention, the performance evaluation of electrochemical synthetic ammonia is:

### Embodiment 1

This embodiment provides a resin-based composite nuclear shielding material. Based on the weight of the nuclear shielding material, the shielding material includes the following components: 41 wt % of epoxy resin, 49 wt % of functional filler, 3 wt % of curing agent and 7 wt % of silane coupling agent, where the weight sum of each component is 100%.

The preparation method includes the following steps: 1) 10 g of epoxy resin was heated to 60° C. in a constant-temperature water bath kettle; 2) 10 g of carbon nanotube and 12 g of polyvinylpyrrolidone were added into 600 ml of deionized water solution for uniformly stirring to obtain a mixed solution; 3) 12 g of erbium oxide was added into the mixed solution and stirred for 36 hours; 4) the solution was washed with deionized water for many times and was placed into a vacuum drying oven at 70° C. and dried for 8 hours to obtain functional filler powder; 5) 12 g of functional filler powder was added into 80 ml of acetone solution, and ultrasonic dispersion was performed for 10 minutes for uniform mixing; 6) 1.5 g of silane coupling agent was added into the solution, and ultrasonic dispersion was performed continuously for 10 minutes; 7) the preheated resin was added into the solution, and was heated and stirred at 60° C. until acetone is completely volatilized; 8) 0.8 g of triethylenetetramine was added into the solution and stirred for uniform mixing; and 9) the mixture was poured into a mold, curing was performed in the vacuum drying oven at 50° C. for 6 hours, and then demolding was performed to obtain an epoxy resin-based composite nuclear shielding material.

### Embodiment 2

This embodiment provides a resin-based composite nuclear shielding material. Based on the weight of the nuclear shielding material, the shielding material includes the following components: 46 wt % of organic silicon resin, 46 wt % of functional filler, 3 wt % of curing agent and 5 wt % of silane coupling agent, where the weight sum of each component is 100%.

The preparation method includes the following steps: 1) 10 g of organic silicon resin was heated to 80° C. in a constant-temperature water bath kettle; 2) 10 g of carbon nanotube and 10 g of polyvinylpyrrolidone were added into 500 ml of deionized water solution for uniformly stirring to obtain a mixed solution; 3) 10 g of lead oxide was added into the mixed solution and stirred for 24 hours; 4) the solution was washed with deionized water for many times and was placed into a vacuum drying oven at 60° C. and dried for 12 hours to obtain functional filler powder; 5) 10 g of functional filler powder was added into 50 ml of acetone solution, and ultrasonic dispersion was performed for 5 minutes for uniform mixing; 6) 1 g of silane coupling agent was added into the solution, and ultrasonic dispersion was performed continuously for 5 minutes; 7) the preheated resin was added into the solution, and was heated and stirred at 50° C. until acetone is completely volatilized; 8) 0.7 g of ethylenediamine was added into the solution and stirred for uniform mixing; and 9) the mixture was poured into a mold, curing was performed in the vacuum drying oven at 40° C. for 6 hours, and then demolding was performed to obtain an epoxy resin-based composite nuclear shielding material.

### Embodiment 3

This embodiment provides a resin-based composite nuclear shielding material. Based on the weight of the nuclear shielding material, the shielding material includes the following components: 37 wt % of phenolic resin, 53 wt % of functional filler, 7 wt % of curing agent and 3 wt % of silane coupling agent, where the weight sum of each component is 100%.

The preparation method includes the following steps: 1) 10 g of phenolic resin was heated to 60° C. in a constant-temperature water bath kettle; 2) 10 g of carbon nanotube and 15 g of polyvinylpyrrolidone were added into 800 ml of deionized water solution for uniformly stirring to obtain a mixed solution; 3) 14 g of gadolinium oxide was added into the mixed solution and stirred for 36 hours; 4) the solution was washed with deionized water for many times and was placed into a vacuum drying oven at 80° C. and dried for 10 hours to obtain functional filler powder; 5) 14 g of functional filler powder was added into 100 ml of acetone solution, and ultrasonic dispersion was performed for 8 minutes for uniform mixing; 6) 2 g of silane coupling agent was added into the solution, and ultrasonic dispersion was performed continuously for 8 minutes; 7) the preheated resin was added into the solution, and was heated and stirred at 60° C. until acetone was completely volatilized; 8) 0.9 g of diethylenetriamine was added into the solution and stirred for uniform mixing; and 9) the mixture was poured into a mold, curing was performed in the vacuum drying oven at 50° C. for 5 hours, and then demolding was performed to obtain an epoxy resin-based composite nuclear shielding material.

### Embodiment 4

This embodiment provides a resin-based composite nuclear shielding material. Based on the weight of the nuclear shielding material, the shielding material includes the following components: 35 wt % of epoxy resin, 52 wt % of functional filler, 3 wt % of curing agent and 10 wt % of silane coupling agent, where the weight sum of each component is 100%.

The preparation method includes the following steps: 1) 10 g of epoxy resin was heated to 50° C. in a constant-temperature water bath kettle; 2) 10 g of carbon nanotube and 20 g of polyvinylpyrrolidone were added into 1000 ml of deionized water solution for uniformly stirring to obtain a mixed solution; 3) 20 g of tungsten oxide was added into the mixed solution and stirred for 48 hours; 4) the solution was washed with deionized water for many times and was placed into a vacuum drying oven at 100° C. and dried for 8 hours to obtain functional filler powder; 5) 15 g of functional filler powder was added into 150 ml of acetone solution, and ultrasonic dispersion was performed for 10 minutes for uniform mixing; 6) 3 g of silane coupling agent was added into the solution, and ultrasonic dispersion was performed continuously for 10 minutes; 7) the preheated resin was added into the solution, and was heated and stirred at 80° C. until acetone is completely volatilized; 8) 1 g of diethylenetriamine was added into the solution and stirred for uniform mixing; and 9) the mixture was poured into a mold, curing was performed in the vacuum drying oven at 60° C. for 4 hours, and then demolding was performed to obtain an epoxy resin-based composite nuclear shielding material.

### Comparative Example 1

A resin-based nuclear shielding material is provided. Based on the weight of the nuclear shielding material, the shielding material includes the following components: 90 wt % of epoxy resin and 10 wt % of curing agent, where the weight sum of each component is 100%.

The preparation method includes the following steps: 1) 9 g of epoxy resin was heated to 60° C. in a constant-temperature water bath kettle; 2) 1.0 g of triethylenetetramine was added into the solution and stirred for uniform mixing; and 3) the mixture was poured into a mold, curing was performed in a vacuum drying oven at 50° C. for 6 hours, and then demolding was performed to obtain an epoxy resin-based nuclear shielding material.

### Comparative Example 2

Except that a functional filler is not added in the components of the shielding material, the shielding material includes 90 wt % of epoxy resin, 3 wt % of curing agent and 7 wt % of silane coupling agent, where the weight sum of each component is 100%, and other experiment settings are the same as those in Embodiment 1.

### Comparative Example 3

Except that a silane coupling agent is not added in the components of the shielding material, the shielding material includes 48 wt % of epoxy resin, 49 wt % of functional filler and 3 wt % of curing agent, where the weight sum of each component is 100%, and other experiment settings are the same as those in Embodiment 1.

### Comparative Example 4

Except that the ratio of functional filler powder to acetone is 1 g:15 mL, other experiment settings are the same as those in Embodiment 1.

### Comparative Example 5

Except that the ratio of functional filler powder to acetone is 1 g:1 mL, other experiment settings are the same as those in Embodiment 1.

### Comparative Example 6

Except that the ratio of functional filler powder to silane coupling agent is 15:1, other experiment settings are the same as those in Embodiment 1.

### Comparative Example 7

Except that the ratio of functional filler powder to silane coupling agent is 1:1, other experiment settings are the same as those in Embodiment 1.

### Comparative Example 8

Except that the ratio of resin to functional filler powder is 1:2, other experiment settings are the same as those in Embodiment 1.

### Comparative Example 9

Except that the ratio of resin to functional filler powder is 2:1, other experiment settings are the same as those in Embodiment 1.

### Comparative Example 10

Except that the mass ratio of functional nanoparticles to carbon nanotubes is 1:4, other experiment settings are the same as those in Embodiment 1.

### Comparative Example 11

Except that the mass ratio of functional nanoparticles to carbon nanotubes is 4:1, other experiment settings are the same as those in Embodiment 1.

### Comparative Example 12

Except that the mass ratio of curing agent to resin agent is 1:5, other experiment settings are the same as those in Embodiment 1.

### Comparative Example 13

Except that the mass ratio of curing agent to resin is 1:15, other experiment settings are the same as those in Embodiment 1.

For the detection of the physical and mechanical properties of a neutron shielding composite material in the above embodiments and comparative examples, a ²⁵²Cf neutron source is selected for test, the average energy of the neutron is 2.13 MeV, a neutron detector includes a moderating ball and a He-3 proportional counter, and the shielding coefficient and transmittance of the shielding material A-C on the neutrons are calculated based on the neutrons before and after the neutrons pass through the shielding material A-C (1 cm thickness). The tensile strength and the compressive strength of the shielding material A-C subjected to 150 C and 14-day thermal agent test and subjected to 10⁵ Gy gamma-ray irradiation are respectively tested according to the method stipulated in GB/T 10401-2006 Plastics-Determination of Tensile Properties—Part 1: General Principles. The test result is shown in Table 1.

TABLE 1

| | Tensile | Compressive | Neutron | Neutron source |
|---|---|---|---|---|
| | strength | strength | transmittance | shielding |
| | (Mpa) | (Mpa) | (%) | coefficient |
| Embodiment 1 | 24.3 | 25.1 | 29% | 2.73 |
| Embodiment 2 | 23.8 | 24.6 | 28% | 2.66 |
| Embodiment 3 | 24.1 | 24.9 | 28% | 2.70 |
| Embodiment 4 | 23.9 | 24.7 | 29% | 2.71 |
| Comparative | 14.2 | 15.2 | 16% | 1.88 |
| Example 1 | | | | |
| Comparative | 15.2 | 16.2 | 19% | 2.20 |
| Example 2 | | | | |
| Comparative | 15.4 | 16.7 | 20% | 2.15 |
| Example 3 | | | | |
| Comparative | 16.2 | 18.3 | 22% | 2.26 |
| Example 4 | | | | |
| Comparative | 16.8 | 18.6 | 22% | 2.32 |
| Example 5 | | | | |
| Comparative | 16.6 | 19.1 | 23% | 2.31 |
| Example 6 | | | | |
| Comparative | 17.2 | 18.9 | 23% | 2.29 |
| Example 7 | | | | |
| Comparative | 20.3 | 21.2 | 25% | 2.39 |
| Example 8 | | | | |
| Comparative | 20.6 | 20.9 | 25% | 2.36 |
| Example 9 | | | | |
| Comparative | 20.2 | 20.6 | 25% | 2.35 |
| Example 10 | | | | |
| Comparative | 20.5 | 20.9 | 24% | 2.38 |
| Example 11 | | | | |
| Comparative | 21.6 | 21.2 | 25% | 2.42 |
| Example 12 | | | | |
| Comparative | 21.3 | 21.4 | 25% | 2.45 |
| Example 13 | | | | |

It can be seen from Comparative Example 1 that if the functional filler and the silane coupling agent are not added, as shown in Table 1, the tensile strength, the compressive strength, the neutron transmittance and other effects of the obtained composite material are greatly reduced. It can be seen from Comparative Examples 2 to 3 that in a case that the functional filler and the silane coupling agent are not added, according to the measurement and calculation results of the tensile strength, the compressive strength, the neutron transmittance and the neutron source shielding coefficient that the effects of the tensile strength and the compressive strength are obviously reduced. It can be seen from Comparative Examples 4 to 5 that after the ratio of the functional filler powder to the acetone is changed, the adding quantity of the functional filler powder and the acetone greatly affects the performance of the material, and too high and too low adding quantities cannot achieve a perfect effect. It can be seen from Comparative Examples 6 to 7 that after the mass ratio of the functional filler powder to the silane coupling agent is changed, the ratio of the functional filler powder to the silane coupling agent also obviously affects the performance of the composite material; the silane coupling agent can enhance the binding force of the filler and the matrix resin, so that the composite material still has high mechanical property at high temperature; the silane coupling agent also can improve the corrosion resistance of the composite material; the silane coupling agent can make the composite material have higher corrosion resistance by enhancing the binding force of the filler and the matrix resin; and the silane coupling agent can improve the processing performance of the composite material, such as the flowability and the plasticity of the resin, so that the composite material can be processed into various shapes more easily. Meanwhile, the functional filler powder also can improve the processing performance of the composite material and reduce the processing difficulty, but the too high and too low quantities of the two will affect the tensile strength, the compressive strength, the neutron transmittance and other effects of the composite material. It can be seen from Comparative Example 8 to 9 that after the mass ratio of the resin to the functional filler powder is changed, the fusion effect of the resin and the functional filler powder also has a certain ratio, but does not meet that the higher, the better the effect. It can be seen from Comparative Example 10 to 11 that the nanoparticles and the carbon nanotubes have extremely high specific surface area and strong mechanical property, and when the nanoparticles and the carbon nanotubes are added into the composite material, the strength, the hardness, the toughness and other mechanical properties of the composite material can be effectively improved. The wear resistance of the composite material can be improved, so that the composite material has lower wear rate and longer service life in the friction process, has higher corrosion resistance and excellent barrier property, has high biocompatibility and has rich surface modification performance. After the mass ratio of the functional nanoparticles to the carbon nanotubes is changed, the effects generated by the formed structures are different. It can be seen from Comparative Examples 12 to 13 that after the mass ratio of the curing agent to the resin is changed, the performance of the composite material will also be affected. In conclusion, it can be seen that there is a strict ratio between the effects of the composite material, and the optimal effect can be achieved only within a reasonable range.

According to the present invention, the production cost of the composite material can be reduced by using the functional filler powder and the silane coupling agent. This is because the functional filler powder and the silane coupling agent can replace the traditional raw materials to a certain extent, for example, the use amount of the resin is reduced. The use of the environmentally-friendly silane coupling agent and the pollution-free functional filler powder can improve the environment friendliness of the composite material. Therefore, the influence of the composite material on the environment during production and use can be reduced.

It should be noted that the above embodiments are merely used to describe, but not to limit, the technical solution of the present invention. Although the present invention is described in detail with reference to the preferred embodiments, those of ordinary skill in the art should understand that the technical solution of the present invention can be modified or equivalently replaced without departing from the spirit and scope of the technical solution of the present invention, and should be included in the scope of the present invention.

What is claimed is:

1. A preparation method for a resin-based composite nuclear shielding material, comprising:
heating a resin at a constant temperature;
adding a carbon nanotube and polyvinylpyrrolidone into a deionized water solution, stirring uniformly to obtain a mixed solution, and adding functional nanoparticles into the mixed solution for stirring to obtain a solution A;
washing the solution A with deionized water and drying to obtain functional filler powder; adding the functional filler powder into an acetone solution, and performing ultrasonic dispersion for uniform mixing to obtain a solution B;
adding a silane coupling agent into the solution B, and continuously performing ultrasonic dispersion to obtain a solution C; and
adding the preheated resin into the solution C, heating and stirring until acetone is completely volatilized, adding a curing agent, stirring to mix the materials uniformly, pouring the mixture into a mold, performing curing in a vacuum drying oven and then performing demolding to obtain an epoxy resin-based composite nuclear shielding material.

2. The preparation method according to claim 1, wherein the mass percentage of each raw material is as follows: 37%-41% of resin, 46%-53% of functional filler, 3%-7% of curing agent and 3%-10% of silane coupling agent.

3. The preparation method according to claim 1, wherein the resin is heated in a constant-temperature water bath kettle, a resin matrix being any one of epoxy resin, organic silicon resin and phenolic resin, and the heating temperature being 50° C.-80° C.

4. The preparation method according to claim 1, wherein the mass ratio of the carbon nanotube to the polyvinylpyrrolidone is 1:1-1:2, and the ratio of the carbon nanotube to the deionized water is 1 g:(0.05-0.1) L.

5. The preparation method according to claim 1, wherein in the adding functional nanoparticles into the mixed solution for stirring to obtain the solution A, the stirring time is 24-48 hours, each of the functional nanoparticles is one of tungsten oxide, lead oxide, gadolinium oxide and erbium oxide, and the mass ratio of the functional nanoparticles to the carbon nanotube is 1:1-1:2.

6. The preparation method according to claim 1, wherein in the washing the solution A with deionized water and drying, the temperature is 60° C.-100° C., the time is 8-12 hours, and the ultrasonic dispersion time is 5-10 minutes.

7. The preparation method according to claim 1, wherein the ratio of the functional filler powder to the acetone is 1 g:(5-10) mL, the mass ratio of the functional filler powder to the silane coupling agent is 5:1-10:1, and the mass ratio of the resin to the functional filler powder is 1:1-1:1.5.

8. The preparation method according to claim 1, wherein in the heating and stirring until acetone is completely volatilized, the heating temperature is 50° C.-80° C.

9. The preparation method according to claim 1, wherein the curing agent is selected from any one of diethylenetriamine, ethylenediamine, diethylenetriamine and triethylenetetramine, and the mass ratio of the curing agent to the resin is 1:7-1:10.

10. The preparation method according to claim 1, wherein in the performing curing in a vacuum drying oven, the temperature is 40° C.-60° C., and the curing time is 4-6 hours.
